(19) United States
(12) Patent Application Publication
(10) Pub. No.: US 2009/0097546 A1
(43) Pub. Date: Apr. 16, 2009

(54) SYSTEM AND METHOD FOR ENHANCED VIDEO COMMUNICATION USING REAL-TIME SCENE-CHANGE DETECTION FOR CONTROL OF MOVING-PICTURE ENCODING DATA RATE

(76) Inventors: Chang-Hyun LEE, Suwon-si (KR); Kwan-Woong SONG, Seongnam-si (KR); Young-O PARK, Yongin-si (KR); Yong-Serk KIM, Seoul (KR); Young-Hun JOO, Yongin-si (KR); Tae-Sung PARK, Suwon-si (KR); Jae-Hoon KWON, Seongnam-si (KR); Do-Young JOUNG, Seoul (KR); Jae-Sung PARK, Gunpo-si (KR); Sung-Kee KIM, Hwaseong-si (KR); Yong-Gyoo KIM, Seoul (KR); Yun-Je OH, Suwon-si (KR)

Correspondence Address: CHA & REITER, LLC, 210 ROUTE 4 EAST STE 103, PARAMUS, NJ, 07652, US

(21) Appl. No.: 12/249,018

(22) Filed: Oct. 10, 2008

(30) Foreign Application Priority Data
Oct. 10, 2007 (KR) 2007-0102009
Jul. 31, 2008 (KR) 2008-0075307

(51) Int. Cl. H04N 7/26

(52) U.S. Cl. 375/240.02; 375/E07.154

(57) ABSTRACT

Disclosed is a method for detecting a scene change in real time in order to control a moving-picture encoding data rate, the method including: dividing a current frame into a plurality of regions, and calculating a dissimilarity metric (DM) of each divided region; determining if the dissimilarity metric of each divided region is beyond a preset reference value; calculating the number of regions, the dissimilarity metric of which is beyond the preset value, in the current frame; and determining that a scene change occurs in the current frame, when the number of regions, the dissimilarity metric of which is beyond the reference preset value, is equal to or greater than a preset threshold value.

### CLAIM OF PRIORITY

This application claims priority to application entitled “Method For Real-Time Scene-Change Detection For Moving-Picture Encoding Data Rate Control, Method For Enhancing Quality Of Video Communication Using The Same, And System For The Video Communication,” filed with the Korean Intellectual Property Office on Oct. 10, 2007 and assigned Serial No. 2007-102009 and on Jul. 31, 2008 and assigned Serial No. 2008-75307 the contents of which are incorporated herein by reference in their entirety.

### BACKGROUND OF THE INVENTION

1. Field of the Invention

The present invention relates to moving-picture encoding, and more particularly to a method for real-time scene-change detection, which is previously performed for controlling the data rate for moving-picture encoding upon encoding of a moving picture.

2. Description of the Related Art

Various digital moving picture compression technologies have been proposed in order to acquire a low data rate or to minimize the amount of data to be stored, as well as to maintain high image quality, when moving-picture signals are transmitted or stored. Such moving picture compression technology is disclosed in a number of international standards, such as H.261, H.263, H264, MPEG-2, MPEG-4, etc. These compression technologies provide relatively high compression rates through a Discrete Cosine Transform (DCT) scheme, a Motion Compensation (MC) scheme, etc. These moving picture compression technologies are used for efficient transfer of moving-picture data streams to various digital networks, for example, a mobile phone network, a computer network, a cable network, a satellite network and the like. Also, these moving picture compression technologies are employed to efficiently store moving-picture data streams in storage media, such as a bard disk, an optical disk, a Digital Video Disk (DVD), etc.

In order to obtain high-quality images of moving pictures, a large amount of moving picture data must be encoded. However, a data rate usable for encoding may have a limit in a communication network through which the moving picture data is transferred. For example, data channels of either a satellite broadcasting system or a digital cable television network usually transmit data at a constant bit rate (CBR). Also, storage capacity of storage media, such as a disk, is limited.

Accordingly, a moving-picture encoding process performs an appropriate trade-off between an image quality and a number of bits required for image compression. Since the moving-picture encoding requires a relatively complex process to produce an encoded moving-picture data, for example, when the moving-picture encoding is to be implemented by software, the moving-picture encoding process requires a relatively large number of CPU cycles. Moreover, when the encoded moving-picture data is processed and reproduced in real time, a time constraint limits accuracy in an encoding operation, thereby limiting an obtainable image quality.

As described above, the data rate control of moving-picture encoding is an important factor in an actual use environment. For this reason, moving-picture encoding data rate control schemes have been proposed for not only reducing the complexity of the processing scheme and the data rate, but also obtaining images having as high a quality as possible.

Joint Video Team (JVT: ITU-T Video Coding Experts Group and ISO/IEC 14496-10 AVC Moving Picture Experts Group, Z. G. Li, F. Pan, K. P. Lim, G Feng, X. Lin, and S. Rahardja, “Adaptive basic unit layer rate control for JVT”, JVT-G012-r1, 7^{th} Meeting Pattaya II, Thailand, March 2003.) discloses a basic technology for controlling the data rate through adjustment of a quantization parameter (QP) when moving-picture frame encoding is performed according to an MPEG moving-picture compression algorithm.

Meanwhile, the flow of controlling the encoding data rate is broken if a scene change occurs at an inter-frame in a group of picture (GOP) when a moving picture is encoded at the condition where given resources (e.g. a data rate, etc.) are restricted. This is because the encoding data rate control is made under the condition where each frame is similar to a previous frame. Therefore, a method of detecting a scene change in real time is required in order to prevent the aforementioned problem from occurring.

In order to detect a scene change, methods, such as a correlation, a statistical sequential analysis, a histogram, etc., are used to find similarity between adjacent frames. Also, in a moving picture compressed by H.264/AVC, it is possible that an intra-coded macroblock exists within an inter-frame in a process of rate distortion optimization (RDO), and an inter-frame may be considered as a scene-change frame when the number of intra-coded macroblocks within the inter-frame exceeds a predetermined level.

However, the method of determining if a scene change is generated based on the number of intra-coded macroblocks existing within an inter-frame in a moving picture compressed by H.264/AVC is simple, but it is not possible to process the detection in real time. That is, it is not possible to identify the number of intra-coded macroblocks existing within an inter-frame without a quantization parameter (QP), due to “Chicken & Egg dilemma” generated in an H.264/AVC RDO process.

In order to solve such a problem, studies have been conducted in relation to a method of determining if a scene change is generated by measuring dissimilarity between frames. Methods of measuring dissimilarity between frames are classified into a method using a dissimilarity metric (DM) between compressed images and a method using a DM between non-compressed images.

Since a scene change detection is performed in order to control the bit rate of a moving picture, the scene change detection must be completed before the control for the bit rate of the moving picture is performed. In addition, before an image compression process is performed through the control for the bit rate of the moving picture, a quantization parameter (QP) must be calculated. Consequently, since the scene change detection must be performed before an image compression is performed, it is not possible to calculate a dissimilarity metric between compressed images in real time.

Meanwhile, with respect to non-compressed images, a mean square error (MSE) for a frame may be used to measure a dissimilarity metric between the images. When a dissimilarity metric is calculated using a mean square error, the calculation does not require a large amount of operations because the calculation is performed based on pixels of a frame, but the performance of detecting a scene change in images having a lot of motion is not very good. In order to solve such a disadvantage, a method of calculating a dissimilarity metric by taking into consideration not only pixels of a frame, but also a histogram, may be employed. In detail, a method using all four types of dissimilarity metrics (4DMs), that is, mean absolute frame difference (MAFD), MAFD after histogram equalization with normalization (HEN), signed difference MAFD (SDMAFD) after HEN, and absolute difference frame variance (ADFV) after HEN, has been attempted. The method using 4DMs has an excellent performance in scene change detection, but it requires a large number of operations. For this reason, it is not easy to detect a scene change between frames in real time through the method using 4DMs.

### SUMMARY OF THE INVENTION

Accordingly, the present invention provides a real-time scene-change detection method for moving-picture encoding data rate control, by which a scene change can be more efficiently detected in real time, and the complexity of hardware can be reduced.

In addition, the present invention provides a method for detecting an image generated due to error, and improving the quality of an image through use of the detected image.

In accordance with an exemplary embodiment of the present invention, a method is provided for detecting a scene change in real time in order to control a moving-picture encoding data rate, the method including the steps of: dividing a current frame into a plurality of regions, and calculating a dissimilarity metric (DM) of each divided region; determining if the calculated dissimilarity metric of each divided region is beyond a preset reference value; checking the number of regions, the dissimilarity metric of which is beyond the preset value, in the current frame; and determining that a scene change occurs in the current frame, when the number of regions, the dissimilarity metric of which is beyond the preset value, is equal to or greater than a preset threshold value.

The step of calculating the dissimilarity metric (DM) of each divided region may include a step of predicting a peak signal-to-noise ratio (PSNR) of a current frame before encoding, through use of inters ample error information between the current frame and a reconstructed previous frame (i.e., reference frame).

In the step of calculating the dissimilarity metric (DM) of each divided region, the dissimilarity metric of each divided region may be calculated through use of a predicted peak signal-to-noise ratio (PPSNR) predicted in the current frame and an average PPSNR of frames generated after a scene change occurs.

In addition, the method may further include the steps of: calculating a differential value of a predicted PSNR of a frame input after a frame where a scene change occurs; and checking a resultant value of the calculation, and establishing a corresponding frame as a frame at which the scene change is terminated when the resultant value corresponds to a negative value.

In accordance with another exemplary embodiment of the current invention, there is provided a method for enhancing a quality of a video communication by a wireless terminal, the method including the steps of: detecting a start frame and an end frame of a sudden change period in an input moving-picture signal of a terminal; skipping, by a transmission unit, an encoding operation on the detected images; and copying, by a reception unit, a previously received frame in place of the skipped frames, and reproducing the copied frame in place of the skipped frames, wherein the detection of the end frame is achieved through a differentiation of predicted signal-to-noise ratios (PPSNRs) obtained between an input image and a reconstructed previous image.

In accordance with still another exemplary embodiment of the present invention, there is provided a system for video communication using a wireless terminal, the system including: a detector for detection of a start frame and an end frame of a sudden change period in an input moving-picture signal of the terminal; a transmission unit for skipping an encoding operation on all detected images; and a reception unit for copying an reproducing a previously received frame in place of the skipped frames, wherein the detector performs the detection operation through a differentiation of predicted signal-to-noise ratios (PPSNRs) obtained between an input image and a reconstructed previous image.

### BRIEF DESCRIPTION OF THE DRAWINGS

The above and other features and advantages of the present invention will be more apparent from the following detailed description taken in conjunction with the accompanying drawings, in which:

FIG. 1 is a block diagram illustrating an example of a configuration of a moving picture encoder device, to which a scene change detection method according to a first exemplary embodiment of the present invention is applied;

FIG. 2 is a view illustrating an example of a frame divided into a plurality of regions according to the first exemplary embodiment of the present invention;

FIG. 3 is a flowchart illustrating an example of a real-time scene detection operation according to the first exemplary embodiment of the present invention;

FIG. 4 is a graph illustrating the results of example tests for the real-time scene detection operation according to the first exemplary embodiment of the present invention; and

FIG. 5 is a block diagram illustrating an example of a configuration of a moving picture encoder device, to which the scene change detection method according to a second exemplary embodiment of the present invention is applied.

### DETAILED DESCRIPTION OF THE INVENTION

Hereinafter, exemplary embodiments of the present invention will be described in detail with reference to the accompanying drawings. In the below description, many particular items such as a detailed example of a component device are shown, but these are given only for providing a general understanding of the present invention. It will be understood by those skilled in the art that various changes in form and detail may be made within the scope of the present invention.

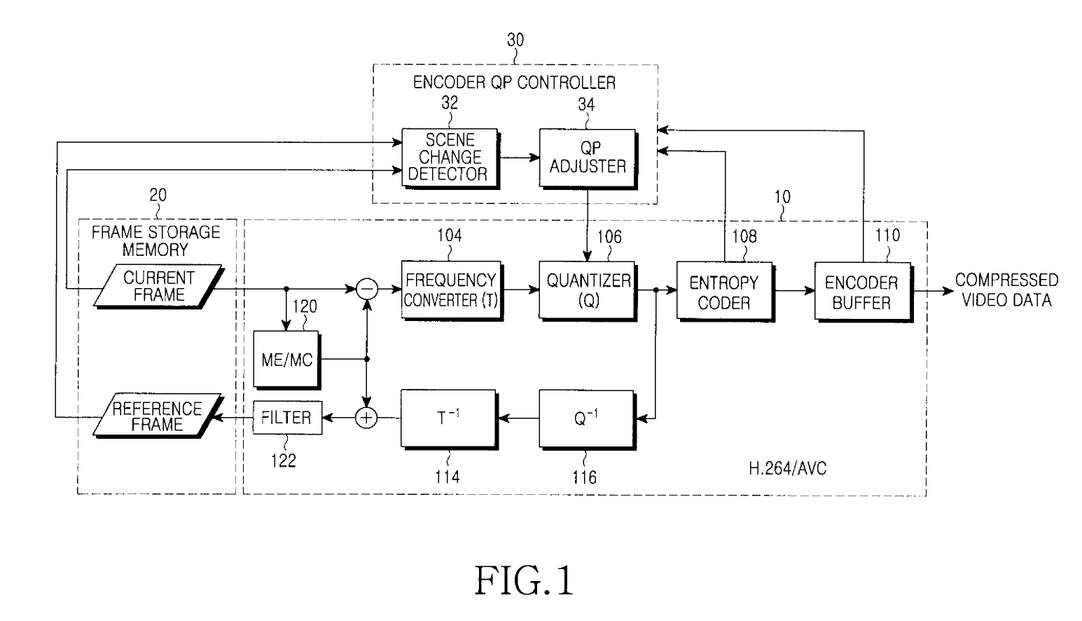

FIG. 1 is a block diagram illustrating an example of a configuration of a video encoder device to which a scene change detection method according to a first exemplary embodiment of the present invention is applied. The video encoder device, to which the scene change detection method according to the first exemplary embodiment of the present invention is applied, includes a general H.264/Advanced Video Coding (AVC) encoder 10 which receives an image frame sequence and outputs compressed video data. In addition, the video encoder device further includes a frame storage memory 20 for storing frames, and an encoder Quantization Parameter (QP) controller 30 for performing a QP control operation for data rate control of the encoder 10.

First, the construction and operation of the video encoder 10 will now be described in more detail. The video encoder 10 includes a frequency converter 104, a quantizer 106, an entropy coder 108, an encoder buffer 110, an inverse quantizer 116, an inverse-frequency converter 114, a motion estimation/compensation unit 120, and a filter 112.

When the current frame is an inter-frame, for example, a P frame, the motion estimation/compensation unit 120 estimates and compensates the motion of a macroblock within the current frame based on a reference frame which is obtained by reconstructing a previous frame buffered in the frame storage memory 20. The frame is processed in units of a macroblock, for example, corresponding to 16×16 pixels in the original image. Each macroblock is encoded to an intra or inter mode. In estimating a motion, motion information such as a motion vector is output as supplementary information. In compensating a motion, a motion-compensated current frame is generated by applying the motion information to a reconstructed previous frame. Then, a difference between the macroblock (estimation macroblock) of the motion-compensated current frame and the macroblock of the original current frame is provided to the frequency converter 104.

The frequency converter 104 converts moving picture information of a spatial domain into data (i.e., spectrum data) of frequency domain. In this case, the frequency converter 104 typically performs Discrete Cosine Transform (DCT) to generate DCT coefficient blocks in units of macroblocks.

The quantizer 106 quantizes blocks of spectrum data coefficients output from the frequency converter 104. In this case, the quantizer 106 applies a uniform scholar quantization to the spectrum data in a step-size which is usually varied based on a frame. The quantizer 106 is provided with variable information on the Quantization Parameter (QP) according to each frame from a QP control unit 34 of the encoder QP controller 30 in order to control the data rate.

The entropy coder 108 compresses the output from the quantizer 106, as well as specific supplementary information (i.e. motion information, a spatial extrapolation mode, and a quantization parameter) of a corresponding macroblock. Generally applied entropy coding technology includes arithmetic coding, Huffman coding, run-length coding, Lempel Ziv (LZ) coding, etc. The entropy coder 108 typically applies different coding technologies to different types of information.

Moving picture information compressed by the entropy coder 108 is buffered by the encoder buffer 110. A buffer level indicator of the encoder buffer 110 is provided to the encoder QP controller 30 for data rate control. The moving picture information buffered in the encoder buffer 110 is output or deleted from the encoder buffer 110, for example, at a fixed data rate.

Meanwhile, when the reconstructed current frame is required for subsequent motion estimation/compensation, the inverse quantizer 116 performs inverse quantization on quantized spectrum coefficients. The inverse-frequency converter 114 performs an operation inverse to that of the frequency converter 104, thereby generating an restructured inverse-difference macroblock from the output of the inverse quantizer 116, for example, through inverse DCT conversion. The restructured inverse-difference macroblock is not identical to the original difference macroblock due to influence of a signal loss, etc. When the current frame is an inter-frame, the restructured inverse-difference macroblock is combined with the estimation macroblock of the motion estimation/compensation unit 120, thereby generating a restructured macroblock. The restructured macroblock is stored as a reference frame in the frame storage memory 20 in order to be used for estimation of the next frame. In this case, since the restructured macroblock corresponds to a distorted version of the original macroblock, the deblocking filter 112 is applied to the restructured frame for compensation for discontinuity between macroblocks according to an embodiment of the present invention.

Meanwhile, the encoder QP controller 30, which controls the QP of the encoder 10, includes a scene change detector 32 for detecting a scene change in real time through the current frame, the reference frame, etc., stored in the frame storage memory 20 according to the characteristics of the present invention. When the scene change detector 32 detects a scene change, this detection information is provided to the QP adjuster 34. Accordingly, the QP adjuster 34 appropriately adjusts the QP of the quantizer 106 in the detection of the scene change so as to cope with the scene change of the current frame.

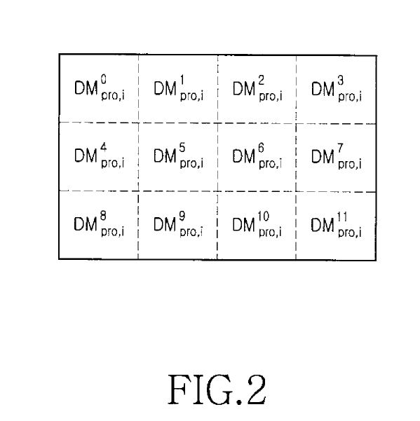

To this end, according to the first exemplary embodiment of the present invention, the scene change detector 32 uses only a predicted peak signal-to-noise ratio (PPSNR) of the current frame in order to prevent the operation load from increasing in a scene change determination process. In detail, the scene change detector 32 divides the current frame into a plurality of regions, as shown in FIG. 2, and predicts the PSNR of each divided region. Then, the scene change detector 32 calculates a dissimilarity metric (DM) of each region, determines if each DM is beyond a preset reference value, and determines the number of regions, the DM of which is beyond the preset reference value, in the frame. When the determined number of regions is equal to or greater than a preset threshold value, the current frame is determined to be a scene change frame.

According to the first exemplary embodiment of the present invention, the dissimilarity metric (DM) of each region is obtained by calculating a ratio of the PSNR of the current frame to an average PPSNR of previous frames so that a local change in a frame can be identified. The dissimilarity metric (DM) may be calculated by equation 1 below.

$${DM}_{proposed , i}^{x} = \frac{{PPSNR}_{i , i - 1}^{x}}{( \frac{1}{i - {s}_{j}} ) {\sum }_{k = {s}_{j} + 1}^{i} {PPSNR}_{k , k - 1}^{x}} \qquad ( 1 )$$

In “DM_{proposed,i}^{x}” of equation 1, “x” represents an identification number of each divided region, “i” represents a frame number of the current frame, and “sⱼ” represents a frame number of a corresponding image corresponding to a j^{th} sudden scene change. “DM_{proposed,i}^{x}” is a ratio of a PPSNR of each region in the current frame to an average PPSNR of each region from the time point when a scene change occurs. Also, “PPSNR_{k,k-1}^{x}” and “PPSNR_{i,i-1}^{x}” may be obtained by equations 2 and 3 below.

$$\begin{matrix}{PPSNR}_{k , k - 1} = 10 {log}_{10} \frac{{( {2}^{n} - 1 )}^{2}}{{PMSE}_{k , k - 1}} & ( 2 ) \\ {PPSNR}_{i , i - 1} = 10 {log}_{10} \frac{{( {2}^{n} - 1 )}^{2}}{{PMSE}_{i , i - 1}} & ( 3 )\end{matrix}$$

In equations 2 and 3, “n” represents the number of bits per sample, i.e. per pixel. Generally, “n” is set to 8. The “PMSE” represents a predicted mean square error (MSE) of the current frame, and may be obtained by equations 4 and 5 below.

$$\begin{matrix}{PMSE}_{k , k - 1} = \frac{1}{MN} {\sum }_{m = 0}^{M - 1} {\sum }_{n = 0}^{N - 1} {( {O}_{mn}^{k} - {R}_{mn}^{k - 1} )}^{2} & ( 4 ) \\ {PMSE}_{i , i - 1} = \frac{1}{MN} {\sum }_{m = 0}^{M - 1} {\sum }_{n = 0}^{N - 1} {( {O}_{mn}^{i} - {R}_{mn}^{i - 1} )}^{2} & ( 5 )\end{matrix}$$

In equations 4 and 5, “Oₘₙ^{k}” represents an original sample in an m^{th} column and an n^{th} row within a k^{th} frame (i.e. current frame), and “Oₘₙⁱ” represents an original sample in an m^{th} column and an n^{th} row within an i^{th} frame (i.e. current frame). In equations 4 and 5, “Rₘₙ^{k-1}” represents a reconstructed reference sample in an m^{th} column and an n^{th} row within a (k−1)^{th} frame (i.e. previous frame), and “Rₘₙⁱ⁻¹” represents a reconstructed reference sample in an m^{th} column and an n^{th} row within a (i−1)^{th} frame (i.e. previous frame). One frame is constituted by M[m]×N[n] pixels.

According to the first exemplary embodiment of the present invention, whether or not the current frame is a scene change frame is determined by identifying how many regions have a dissimilarity metric “DM_{proposed,i}^{x}” less than a preset reference value among a plurality of regions constituting a frame.

A region having a dissimilarity metric “DM_{proposed,i}^{x}” less than the preset reference value is determined by equation 6 below, and whether or not a scene change occurs is determined by equation 7 below.

$$\begin{matrix}{C}^{x} = \{ \begin{matrix}1 ; {DM}_{proposed , i}^{x} < β \\ 0 ; else\end{matrix} & ( 6 ) \\ {\sum }_{x = 0}^{{N}_{f} - 1} {C}^{x} \geq α \cdot {N}_{f} & ( 7 )\end{matrix}$$

In equation 6, “β” represents a preset reference value for a dissimilarity metric “DM_{proposed,i}^{x}” of each region. In equation 7, “α” represents a preset threshold value for defining a ratio for determining whether or not a scene change occurs in a frame, and “N_{f}” represents the number of divided regions in a frame.

For example, “N_{f}” is defined to have a value of 12, “α” is defined to have a value of 0.75, and “β” is defined to have a value of 0.7. In this case, when the number of divided regions having a dissimilarity metric “DM_{proposed,i}^{x}” less than 0.7 is equal to or greater than 9, it is determined that the current frame corresponds to a sudden scene change frame. In addition, the values of “α” and “β” may be determined through a simulation.

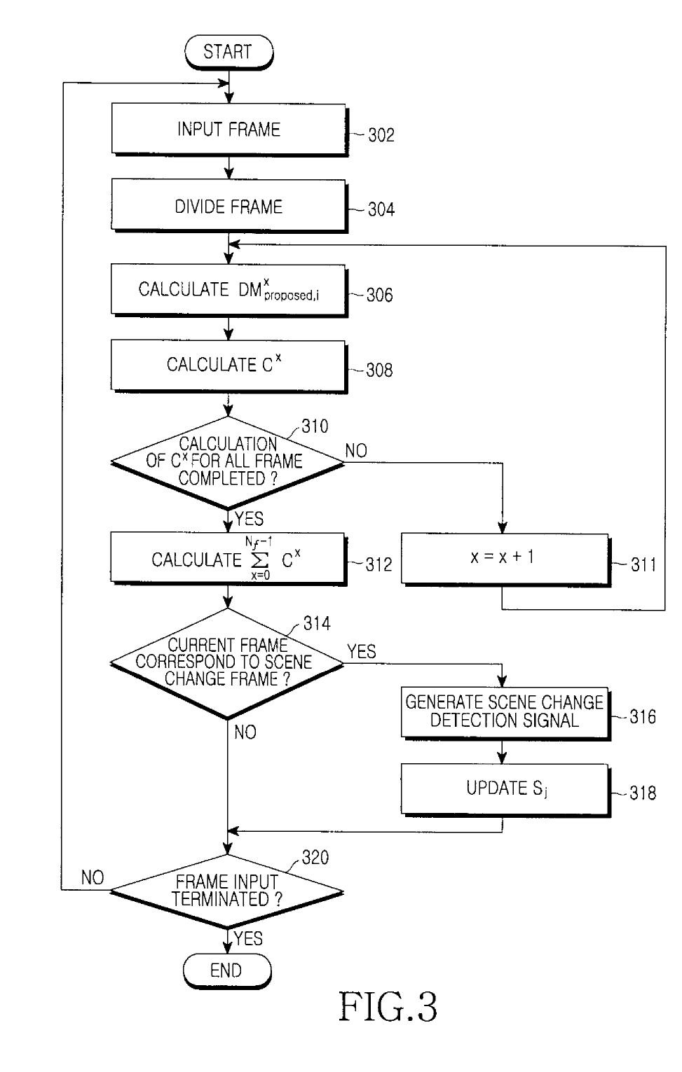

FIG. 3 is a flowchart illustrating a real-time scene detection operation according to the first exemplary embodiment of the present invention, wherein the operation may be performed by the scene change detector 32 shown in FIG. 1. First, an image frame is input in step 302. Next, the input image frame is divided into N_{f} number of regions in step 304. Then, a dissimilarity metric “DM_{proposed,i}^{x}” of each divided region is calculated by equations 1 to 5 in step 306. In step 308, the value of C^{x} for each region is determined by comparing each calculated dissimilarity metric “DM_{proposed,i}^{x}” with a β value, which is a preset reference value, based on equation 6. For example, when the β value is set to 0.7, the value of C^{x} for a region is determined to be “1” if the calculated dissimilarity metric “DM_{proposed,i}^{x}” of the region is less than 0.7, and the value of C^{x} for a region is determined to be “0” if the calculated dissimilarity metric “DM_{proposed,i}^{x}” of the region is equal to or greater than 0.7. After step 308, it is determined if C^{x} values for all regions included in the frame have been determined, by checking the value of “x” and the value of “N_{f},” in step 310. For example, when it is assumed that the frame is divided into 12 regions (i.e. N_{f}=12), as shown in FIG. 2, the value of “x” for a region among the 12 regions, the dissimilarity metric “DM_{proposed,i}^{x}” and the like of which is first calculated, may be set to “0,” and the value of “x” for a region among the 12 regions, the dissimilarity metric “DM_{proposed,i}^{x}” and the like of which is lastly calculated lastly, may be set to “11,” which corresponds to “N_{f}−1.” Accordingly, step 310 may be replaced by a step of determining if the value “x” is identical to the value of “N_{f}−1.” When it is determined in step 310 that C^{x} values for all regions included in the frame have not been determined, step 311 is performed to update the value of “x.” Then, until C^{x} values and dissimilarity metrics “DM_{proposed,i}^{x}” for all regions included in the frame are determined, steps 306, 308, 310, and 311 are repeatedly performed. Meanwhile, when it is determined in step 310 that C^{x} values for all regions included in the frame have been determined, step 312 is performed. In step 312, C^{x} values for all regions, which have been determined in step 308, are added using equation 7. Next, it is determined in step 314 if the current frame corresponds to a sudden scene change frame by comparing a value resulting from the addition with a preset threshold value. For example, in the case where the frame is divided into 12 regions in step 304, and the value of “α” is set to 0.75, when a value resulting from addition of C^{x} values for all regions is 9 or greater, the current frame is determined to be a sudden scene change frame. When it is determined in step 314 that the current frame corresponds to a sudden scene change frame, a scene change detection signal and so on are generated in step 316, and the value of “Sⱼ” used for calculation of dissimilarity metrics “DM_{proposed,i}^{x}” is updated in step 318. The scene change detection signal generated as above may be provided to the QP adjuster 34 in the future, and thus the QP adjuster 34 appropriately adjusts the quantization parameter of the quantizer 106 upon a scene change detection. Meanwhile, when it is determined in step 314 that the current frame does not correspond to a sudden scene change frame, step 320 is performed. In step 320, it is determined if an input frame corresponds to the last frame of an image. When it is determined in step 320 that the input frame corresponds to the last frame of an image, the procedure of determining if a frame corresponds to a scene change frame is terminated. In contrast, when it is determined in step 320 that there is a frame to be input, steps 302 to 318 are repeatedly performed until the last frame is input.

Hereinafter, a result of a simulation will be described to verify the effectiveness of the scene change detection method according to the present invention. First, for the simulation, two test images, including rapid motions and illumination light which make it difficult to detect a sudden scene change, were selected. The selected images are as shown in Table 1 below. The titles of test sequence images were set to “Worldcup” and “FF-X2,” respectively. The two test sequence images are constituted by 6,843 frames and 7,138 frames, respectively, and include 13 sudden scene change frames and 159 sudden scene change frames, respectively.

TABLE 1

| | | | Number of sudden |
|---|---|---|---|
| Sequence | Sequence comment | Number of frames | scene change frames |
| Worldcup | Sports highlight | 6,843 | 13 |
| FF- | Animation highlight | 7,138 | 159 |
| X2 | | | |

Scene changes were detected from the two test sequence images, according to the existing MSEDM, the existing 4DMs, a method (hereinafter, referred to as a “method disclosed in the '856 patent”) disclosed in Korean Patent Application No. 10-2006-0075856 filed by the applicant of the present invention in advance, and a method according to the present invention, respectively, and then errors occurring in the scene change detection procedure were checked and recorded in Table 2 below. In Table 2, the “Number of False” represents the number of cases detected as a scene change although a scene change does not actually occur, and the “Number of MISS” represents the number of cases undetected as a scene change although a scene change actually occurs. In addition, DP_{FalseMiss} (s) according to each method were calculated and recorded. The DP_{FalseMiss} (%) represents a ratio of a sum of the number of FALSEs and the number of MISSs to the number of scene changes included in each image, and resulted from equation 8 below.

$${DP}_{FalseMiss} = \frac{Sum of FALSE and MISS}{Number of Scene Changes Included in IMAGE} \times 100 \qquad ( 8 )$$

TABLE 2

| | ASC detection | Number of | Number | DP_{FalseMiss} |
|---|---|---|---|---|
| Sequence | algorithms | FALSE | of MISS | (%) |
| Worldcup | MSE DM | 2 | 2 | 30.8 |
| | 4DMs | 0 | 1 | 7.7 |
| | Method disclosed in | 3 | 3 | 46.2 |
| | the ′856 patent | | | |
| | Method according to | 0 | 1 | 7.7 |
| | the Present Invention | | | |
| FF- | MSE DM | 97 | 60 | 98.7 |
| X2 | 4DMs | 11 | 50 | 38.4 |
| | Method disclosed in | 52 | 59 | 69.8 |
| | the ′856 patent | | | |
| | Method according to | 31 | 48 | 49.7 |
| | the Present Invention | | | |

Referring to Table 2, it can be understood that the scene change detection method according to the present invention is superior by about 36.1% in detection performance as compared with that of the existing MSD DM scheme, and is inferior by about 5.7% in the detection performance as compared with that of the existing 4DMs scheme.

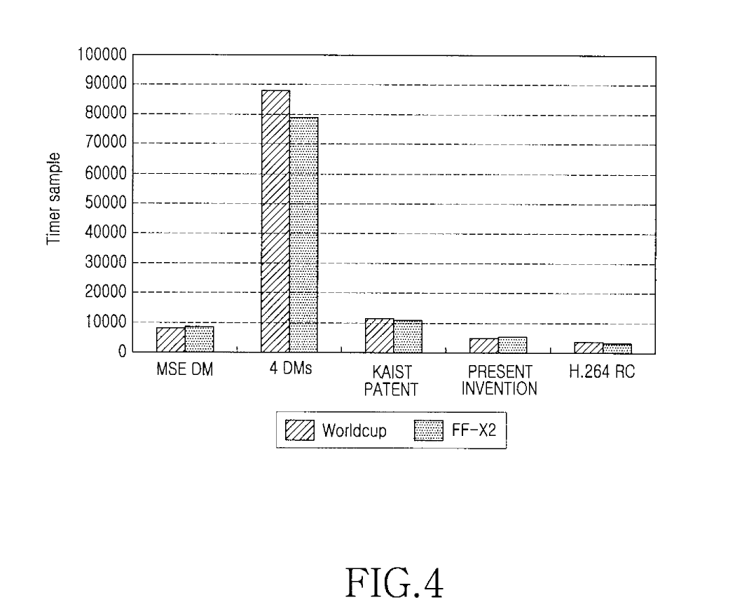

Also, operation loads required for performing the aforementioned methods were checked through a personal computer. The results of the checking are shown as a graph of FIG. 4.

The personal computer for the simulation was equipped with “Microsoft® Windows® XP” as the operating system (OS) thereof, and included a storage medium in which the “Intel® VTune™ Performance Analyzer 8.0” program was recorded. The simulation is set in a time-based mode utilizing an operating system timer in the personal computer, wherein a sampling interval is set to 1 ms. In order to increase the reliability of the simulation, the simulation was performed by using three different personal computers having the aforementioned conditions, and values measured through the three computers were averaged. FIG. 4 is a graph illustrating results measured in terms of operation loads of the algorithms in such a manner as to add all timer samples obtained through the three computers. The algorithm according to the present invention improves the operation load by 34.8% as compared with that of the MSE DM scheme, and improves the operation load by as much as 93.1% as compared with that of the 4DMs scheme. This has great significance, in comparison with the computational load of H.264 frame layer rate control, as shown in FIG. 4. Consequently, the algorithm according to the present invention may be a sudden scene change detection algorithm, which can be applied as an appropriate bit rate control for a sudden scene change upon encoding of an H.264 moving picture. Also, the algorithm according to the present invention may be the optimum algorithm obtained by taking the detection performance and the operation load into consideration, as compared with the conventional algorithms.

The scene change detection method according to the first exemplary embodiment of the present invention, as described above, may be applied to a video communication method of a wireless terminal. That is, with respect to frames occurring in a scene change among images generated for video communication, the scene change detection method according to the first exemplary embodiment of the present invention is applied to appropriately adjust, to encode and to transmit a quantization parameter.

Meanwhile, because of the limit of a physical lens in a mobile terminal, a sudden movement of a mobile terminal generates an unfocused image. Such an unfocused image has little temporal and spatial correlation with adjacent images, thereby consuming a large amount of bit resources upon encoding. When a large amount of bit resources is temporarily consumed, it exerts an influence even upon images normally generated after the sudden movement, thereby dropping image quality as a whole. That is, since allocating unnecessarily more bits to an image, which is unfocused and is difficult to view, exerts a bad effect even upon normal images in the future, therefore, it is necessary to resolve such a problem.

Therefore, according to a second exemplary embodiment of the present invention, an image scene change detection method for detecting frames included in an unfocused image is provided. In detail, the image scene change detection method according to the second exemplary embodiment of the present invention is to detect a frame (hereinafter, referred as a “first frame”) from which a scene change starts due to an unfocused image, and a frame (hereinafter, referred to as a “termination frame”) at which the unfocused image is terminated.

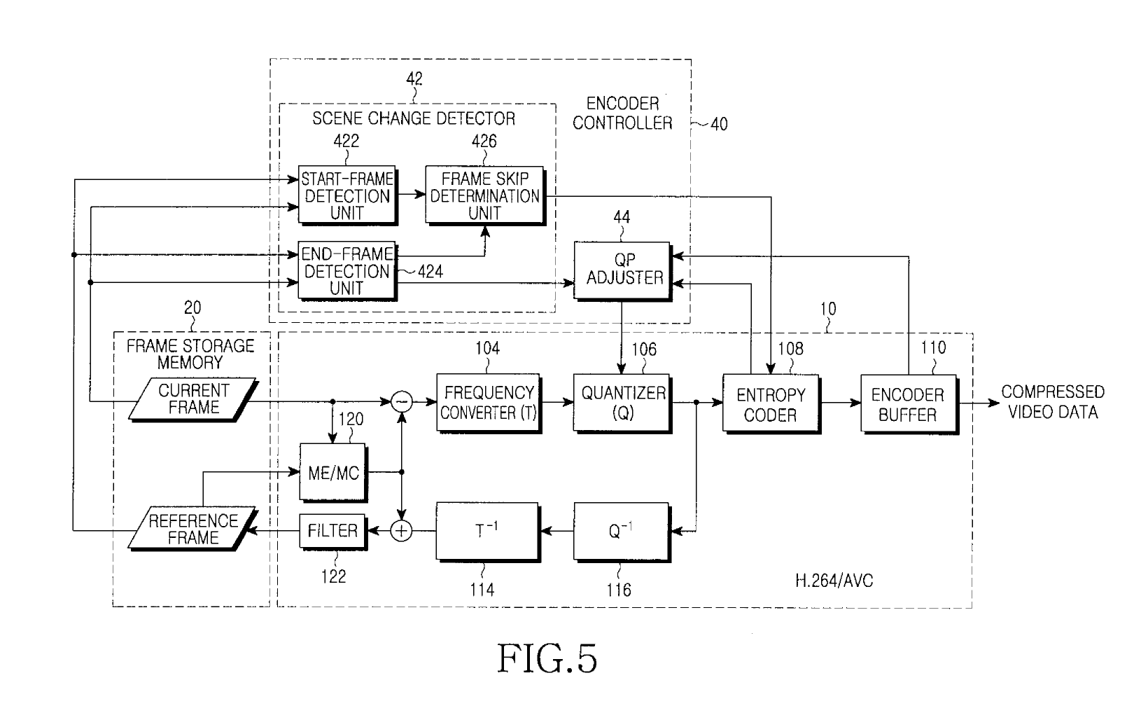

FIG. 5 is a block diagram illustrating an example of the configuration of a moving picture encoder device, to which the scene change detection method according to the second exemplary embodiment of the present invention is applied. The moving picture encoder device, to which the scene change detection method according to the second exemplary embodiment of the present invention is applied, has a construction similar to that of the moving picture encoder device, to which the scene change detection method according to the first exemplary embodiment of the present invention is applied, except for a detailed construction of the scene change detector 32. The same components in the moving picture encoder device according to the second exemplary embodiment of the present invention as those in the moving picture encoder device according to the first exemplary embodiment of the present invention will be indicated with the same reference numerals. In addition, the same components in the moving picture encoder device according to the second exemplary embodiment of the present invention as those in the moving picture encoder device according to the first exemplary embodiment of the present invention have been disclosed in detail in the description regarding the first exemplary embodiment of the present invention, so a detailed description thereof will be omitted.

Meanwhile, according to the moving picture encoder device of the second exemplary embodiment of the present invention, an encoder controller 40 for controlling an encoder 10 includes a scene change detector 42 for detecting a very quick scene change in real time through the current frame, a reference frame, etc., stored in a frame storage memory 20 according to the characteristics of the present invention. The scene change detector 42 includes a start-frame detection unit 422 for detecting a start frame of similar scenes, an end-frame detection unit 424 for detecting an end frame of the similar scenes, and a frame skip determination unit 426 for determining a frame to be skipped.

When a scene change is detected by the scene change detector 42, the detected information is provided to a QP adjuster 44. Accordingly, the QP adjuster 44 appropriately adjusts the QP of a quantizer 106 in the detection of the scene change so as to cope with the scene change of the current frame.

The start-frame detection unit 422 determines if a scene change occurs by predicting the peak signal-to-noise ratio (PSNR) of the current frame and a previously stored reference frame. That is, when the predicted PSNR is beyond a preset threshold value, the current frame is determined to be a scene change frame.

In addition, the start-frame detection unit 422 may detect a start frame through the same operation as that of the scene change detector 32 of the first embodiment of the present invention.

The end-frame detection unit 424 detects an end frame by using a differential value of parameters obtained by predicting the PSNRs of the input current frame and the previously stored reference frame. For example, the end-frame detection unit 424 may detect an end frame by equation 9 below.

That is, in terms of the motion of an image, when the Diff_{AvgPartialPPSNR} has a negative value, it means that the motion in the current frame is less than that in the previous frame. Based on such a fact, the end-frame detection unit 424 determines a frame, the Diff_{AvgPartialPPSNR} of which has a negative value for the first time after the start-frame detection unit 422 has detected a very quick image change (i.e. an unfocused image), to be an end frame.

$${Diff}_{AvgPartialPPSNR} = \frac{{\sum }_{x = 0}^{{N}_{f} - 1} {PPSNR}_{i , i - 1}^{x}}{{N}_{f}} - \frac{{\sum }_{x = 0}^{{N}_{f} - 1} {PPSNR}_{i - 1 , i - 2}^{x}}{{N}_{f}} \qquad ( 9 )$$

In equation 9, “PPSNRs” represent parameters obtained by predicting PSNRs of the input current frame and the stored reference frame, and may be calculated by equation 3 according to the first embodiment of the present invention, “N_{f}” represents the number of blocks into which one frame is divided.

Meanwhile, the frame skip determination unit 426 determines a frame to be skipped through use of information obtained from the start-frame detection unit 422 and the end-frame detection unit 424. When a frame to be skipped is determined, compressed data of the corresponding frame is not transmitted, and only information representing that the corresponding frame has been skipped is transferred to the entropy coder 108.

The QP adjuster 44 receives information on the end frame of the very quick image change (i.e. the unfocused image) from the end-frame detection unit 424. Then, with respect to frames input after the very quick image change (i.e. the unfocused image) is terminated, the QP adjuster 44 performs a data rate control of applying a quantization parameter (QP) according to complexity of images.

Meanwhile, the scene change detection method according to the second exemplary embodiment of the present invention may be applied to a video communication method of a wireless terminal. That is, the scene change detection method according to the second exemplary embodiment of the present invention may be used to detect a very quick image change (e.g. an unfocused image), to skip a frame corresponding to the very quick image change, and to transmit the remaining frames. Also, a receiving terminal may restore a previous frame in place of a skipped image.

In detail, the video communication method may be performed by a wireless terminal equipped with an image transmission device and an image reception device.

During video communication, the image transmission device included the wireless terminal encodes an image photographed by a camera for video communication, and transmits the encoded data to the image reception device. In this case, the image transmission device detects a start frame, at which a very quick image change (e.g. an unfocused image) starts, among images photographed by the camera, and detects an end frame, at which the very quick image change is terminated. Especially, the image transmission device may detect a frame, at which a very quick image change (e.g. an unfocused image) starts, through use of the scene change detection method according to the first exemplary embodiment of the present invention, and may detect an end frame, at which the very quick image change is terminated, through the differential operation of PPSNRs. In addition, the image transmission device inserts a signal, indicating skip of a frame, with respect to frames existing between the start frame and end frame, at which the very quick image change (e.g. an unfocused image) starts and is terminated, respectively, performs an encoding operation, and transmits the encoded data to the receiving terminal.

Meanwhile, the image reception device restores encoded image data, and reproduces the restored image through a display unit. The image reception device can identify the signal indicating skip of a frame, which has been inserted in the encoding process, so that the image reception device copies a frame directly prior to the skipped frame in terms of time, and restores the copied frame in place of the skipped frame.

The methods according to the present invention can be realized as a computer-readable code in a computer-readable recoding medium. The computer-readable recording medium includes all kinds of recording media, in which the computer-readable data is stored. The computer-readable recording medium may be a ROM, a RAM, a CDROM, a magnetic tape, a floppy disk, or an optical data recording medium, or also can be realized in the form of a carrier wave (e.g. transmission through the Internet). Also, the computer-readable recording medium is distributed to the computer systems connected by a network, and can store and perform the computer-readable code in a distributed way.

The real-time scene change detection operation for a moving-picture encoding data rate control according to the exemplary embodiments of the present invention may be implemented as described above. Meanwhile, while the present invention has been shown and described with reference to certain exemplary embodiments thereof, various changes in form and details may be made therein without departing from the scope of the invention.

As described above, the real-time scene change detection method for a moving-picture encoding data rate control according the present invention reduces the complexity of hardware, and can more efficiently detect a scene change in real time. In addition, according to the moving-picture encoding method and system of the present invention, bit resources for unfocused images are accumulated, and allocated for images input later, so that the image quality can be improved.

What is claimed is:

1. A method for detecting a scene change in real time in order to control a moving-picture encoding data rate, comprising:
dividing a current frame into a plurality of divided regions, and calculating a dissimilarity metric (DM) of each divided region;
determining if the dissimilarity metric of each divided region is beyond a preset reference value;
calculating the number of divided regions, the dissimilarity metric of each of which is beyond the preset reference value, in the current frame; and
determining that a scene change occurs in the current frame, when the calculated number of regions, the dissimilarity metric of each of which is beyond the preset reference value, is equal to or greater than a preset threshold value.

2. The method as claimed in claim 1, wherein calculating a dissimilarity metric (DM) of each divided region comprises predicting a peak signal-to-noise ratio (PSNR) of a current frame before encoding, through use of intersample error information between the current frame and a reconstructed previous frame (i.e. reference frame).

3. The method as claimed in claim 2, wherein calculating a dissimilarity metric (DM) of each divided region further comprises calculating the dissimilarity metric of each divided region through use of a predicted peak signal-to-noise ratio (PPSNR) predicted in the current frame and an average PPSNR of frames generated after a scene change occurs.

4. The method as claimed in claim 2, wherein calculating a dissimilarity metric of each divided region is using the equation
$${DM}_{proposed , i}^{x} = \frac{{PPSNR}_{i , i - 1}^{x}}{( \frac{1}{i - {s}_{j}} ) {\sum }_{k = {s}_{j} + 1}^{i} {PPSNR}_{k , k - 1}^{x}} ,$$
in which “x” represents an identification number of each divided region, “i” represents a frame number of the current frame, and “sⱼ” represents a frame number of a corresponding image corresponding to a j^{th} sudden scene change.

5. The method as claimed in claim 4, further comprising calculating the PPSNR values using the equations
$${PPSNR}_{k , k - 1} = 10 {log}_{10} \frac{{( {2}^{n} - 1 )}^{2}}{{PMSE}_{k , k - 1}} and$$
$${PPSNR}_{i , i - 1} = 10 {log}_{10} \frac{{( {2}^{n} - 1 )}^{2}}{{PMSE}_{i , i - 1}} ,$$
in which “PMSE” represents a predicted mean square error (MSE) of the current frame, “n” represents the number of bits per sample, and “PMSE_{i, i-1}” and calculating “PMSE_{k, k-1}” using the equations
$${PMSE}_{k , k - 1} = \frac{1}{MN} {\sum }_{m = 0}^{M - 1} {\sum }_{n = 0}^{N - 1} {( {O}_{mn}^{k} - {R}_{mn}^{k - 1} )}^{2} and$$
$${PMSE}_{i , i - 1} = \frac{1}{MN} {\sum }_{m = 0}^{M - 1} {\sum }_{n = 0}^{N - 1} {( {O}_{mn}^{i} - {R}_{mn}^{i - 1} )}^{2} ,$$
where “Oₘₙⁱ” represents an original sample in an m^{th} column and an n^{th} row within an i^{th} frame, and “Rₘₙⁱ⁻¹” represents a reconstructed reference sample in an m^{th} column and an n^{th} row within an (i−1)^{th} frame, one frame comprising M[m]'N[n] pixels.

6. The method as claimed in claim 1, further comprising determining the number of regions, the dissimilarity metric of which is beyond the preset reference value, is equal to or greater than the preset threshold value, using the equation
$${\sum }_{x = 0}^{{N}_{f} - 1} {C}^{x} \geq α \cdot {N}_{f} ,$$
where “α” represents a threshold value that defines a ratio for determining whether or not a scene change occurs in a frame, “N_{f}” represents the number of divided regions in a frame, and “C^{x}” is determined by
$${C}^{x} = \{ \begin{matrix}1 ; {DM}_{proposed , i}^{x} < β \\ 0 ; else\end{matrix} ,$$
where “β” represents a preset reference value that defines a dissimilarity metric of each region.

7. The method as claimed in claim 1, further comprising:
calculating a differential value of a predicted PSNR of a frame input after a frame where a scene change occurs; and
establishing a corresponding frame as a frame at which the scene change is terminated when the differential value is a negative value.

8. The method as claimed in claim 7, further comprising calculating the differential value of the predicted PSNR using the equation
$${Diff}_{AvgPartialPPSNR} = \frac{{\sum }_{x = 0}^{{N}_{f} - 1} {PPSNR}_{i , i - 1}^{x}}{{N}_{f}} - \frac{{\sum }_{x = 0}^{{N}_{f} - 1} {PPSNR}_{i - 1 , i - 2}^{x}}{{N}_{f}} ,$$
where “PPSNRs” represent parameters obtained by predicting PSNRs of an input current frame and a stored reference frame, and “N_{f}” represents the number of blocks into which one frame is divided.

9. The method as claimed in claim 2, further comprising:
calculating a differential value of a predicted PSNR of a frame input after a frame where a scene change occurs; and
establishing a corresponding frame as a frame at which the scene change is terminated when the differential value is a negative value.

10. The method as claimed in claim 9, further comprising calculating the differential value of the predicted PSNR using the equation
$${Diff}_{AvgPartialPPSNR} = \frac{{\sum }_{x = 0}^{{N}_{f} - 1} {PPSNR}_{i , i - 1}^{x}}{{N}_{f}} - \frac{{\sum }_{x = 0}^{{N}_{f} - 1} {PPSNR}_{i - 1 , i - 2}^{x}}{{N}_{f}} ,$$
where “PPSNRs” represent parameters obtained by predicting PSNRs of an input current frame and a stored reference frame, and “N_{f}” represents the number of blocks into which one frame is divided.
